(19) United States
(12) Patent Application Publication
(10) Pub. No.: US 2024/0050779 A1
(43) Pub. Date: Feb. 15, 2024

(54) WEARABLE AIR PURIFIER

(71) Applicant: Dyson Technology Limited, Wiltshire (GB)

(72) Inventor: Stephen Benjamin COURTNEY, Gloucester (GB)

(73) Assignee: Dyson Technology Limited, Wiltshire (GB)

(21) Appl. No.: 18/267,430

(22) PCT Filed: Oct. 7, 2021
(86) PCT No.: PCT/GB2021/052593

§ 371 Date: Jun. 14, 2023

(30) Foreign Application Priority Data
Dec. 17, 2020 (GB) 2020001.0

(51) Int. Cl. A62B 18/00; B01D 46/10; A62B 18/08; A62B 23/02; H04R 1/10; H04R 1/02

(52) U.S. Cl. CPC A62B 18/003; B01D 46/103; B01D 46/106; A62B 18/08; A62B 18/084; A62B 23/02; A62B 18/006; H04R 1/1008; H04R 1/105; H04R 1/028; B01D 2279/40

(57) ABSTRACT

A wearable air purification system including: a support assembly, including: a first earpiece arranged to engage a first ear of a user, the first earpiece including an air filter; a second earpiece arranged to engage a second ear of the user; and a support member connecting the first earpiece to the second earpiece, the support member being arranged to be worn around the user's head; an air delivery mask connected to the support assembly, the air delivery mask being shaped to bound an air delivery region that contains the user's nose and/or mouth. In use, the air delivery mask includes an outlet in the air delivery region and an air channel configured to deliver a flow of air from the air filter to the outlet. Also, a motor is arranged to drive an impeller to pump air through the air channel to the air delivery region, the motor being housed in the first earpiece and being radially offset from a centre of the air filter.

### TECHNICAL FIELD

The disclosure is directed to improvements relating to wearable air purification systems, or ‘purifiers’.

### BACKGROUND

The wearing of various forms of face mask is increasingly commonplace as air quality concerns become more prominent. Face masks may be used as a means to provide some level of protection against pollen, airborne pathogens, and/or airborne pollutants such as toxic gases or particulates, for example.

Consumer face masks are typically passive and configured simply from one or more layers of fabric material, which is secured to the face of a user by an adjustable strap to act as a basic filter. More sophisticated masks and respirators are available that offer a more comprehensive filtering functionality, for example including pumped air filtration and/or enhanced sealing against the user's face. However, such enhanced air purifying performance usually comes at the expense of comfort, style and clear communication, and so is often reserved for masks for use in special circumstances, for example for personnel working in hazardous environments.

To address this, various approaches have been proposed that are intended to provide enhanced air purification in a consumer-friendly package, for example by avoiding completely obscuring a user's nose and mouth area with a tight-fitting mask. Such approaches may include a mask, or visor, which stretches around in front of a user's nose and mouth and delivers a jet of filtered air using active filtering devices including air pumps and filtration units. The active filtering devices are often located at the front of the visor where the filtered air is required, necessitating a bulky visor that can obscure the user's facial features significantly and more generally can limit the practicality of such purifiers for daily wear.

Another approach is shown in WO 2020/021231, an earlier application belonging to the Applicant, which discloses a wearable air purifier having a wearable support in the form of a headband, to which a pair of earpieces are attached that include air filtration apparatus comprising a combination of filters and air pumps. The purifier further includes a visor including ducting in communication with the air filtration apparatus in the earpieces, to convey filtered air to an area in front of the user's nose and mouth. The earpieces can also include audio equipment, so that the purifier provides the dual functions of purification and audio playback.

The purifier shown in WO 2020/021231 mitigates the problem of the bulky visors seen in other approaches by relocating the active filtering equipment into the earpieces, allowing for a less conspicuous visor that is more suitable for everyday use. However, as a consequence of incorporating the filtration components, the earpieces are relatively large compared with conventional audio headphones.

It is against this background that the present invention has been devised.

### SUMMARY OF THE INVENTION

According to an aspect of the present invention there is provided a wearable air purification system comprising a support assembly, an air delivery mask and a motor. The support assembly comprises: a first earpiece arranged to engage a first ear of a user, the first earpiece comprising an air filter; a second earpiece arranged to engage a second ear of the user; and a support member connecting the first earpiece to the second earpiece, the support member being arranged to be worn around the user's head. The air delivery mask is connected to the support assembly and is shaped to bound an air delivery region that contains the user's nose and/or mouth, in use. The air delivery mask comprises an outlet in the air delivery region and an air channel configured to deliver a flow of air from the air filter to the outlet. The motor is arranged to drive an impeller to pump air through the air channel to the air delivery region, and the motor is housed in the first earpiece and is radially offset from a centre of the air filter.

Positioning the motor in an off-centre location reduces the impact of noise generated by the motor in operation compared with a centrally-positioned motor.

The air filter may extend around a curved path from a first end to a second end, the first and second ends being spaced from each other, in which case the motor is disposed in a gap between the first end and the second end of the filter. The curved path may be generally annular, for example, and the air filter may be C-shaped. Such arrangements beneficially allow for a compact design that reduces the size of the earpiece.

The motor may lie in a common plane with the air filter.

The first and second earpieces may each comprise a respective air filter, each air filter being arranged to deliver filtered air to the air channel of the air delivery mask. In such embodiments, the first and second earpieces may each comprise a respective motor arranged to drive a respective impeller to pump air through the air channel to the air delivery region, each motor being radially offset from a centre of the respective air filter.

The air delivery mask is optionally connected to the first earpiece and/or to the second earpiece.

The first earpiece and the second earpiece may each comprise a respective audio device. For example, the support assembly may function as a set of headphones. Accordingly, the system may comprise a communications module configured to receive a signal comprising audio data.

The air delivery mask outlet may comprise a set of openings arranged in succession from one side of the air delivery region to the other, to distribute air flow from the air channel over the air delivery region.

The system may comprise a pump that comprises the motor and the impeller.

The system is optionally substantially symmetrical about an axis intersecting the air delivery region. For example, the system may have two motors, each positioned in a similar location with respect to an associated one of the earpieces.

The air delivery mask may be coupled to the support assembly by one or more disengageable couplings such that the air delivery mask is detachable from the support assembly.

### BRIEF DESCRIPTION OF THE DRAWINGS

One or more embodiments of the invention will now be described, by way of example only, with reference to the accompanying drawings, in which like features are assigned like numerals, and in which:

FIGS. 1 and 2 show perspective views of a compressor for use in air purifiers of embodiments of the invention;

FIG. 3 is a side schematic view of a wearable air purifier according to an embodiment of the invention in use;

FIG. 4 is a perspective view from above of an air purifier according to an embodiment of the invention;

FIGS. 5 to 7 correspond to FIG. 4 but show top, front and side views respectively of the air purifier;

FIG. 8 shows another perspective view of the air purifier shown in FIG. 4 with positions of motors of the air purifier revealed;

FIG. 9 shows a visor of the air purifier of FIG. 4 in isolation;

FIG. 10 shows a visor of a wearable air purifier according to a different embodiment of the invention;

FIG. 11 shows an air purifier according to another embodiment of the invention; and

FIGS. 12 to 16 correspond to FIGS. 4 to 8 respectively, but show an air purifier according to a further embodiment of the invention.

### DETAILED DESCRIPTION

Examples of the invention will now be described in detail in order to provide a thorough understanding of the inventive concept as defined in the claims. However, it will be apparent to the skilled person that the invention may be put into effect without the specific details set out below and that, in some instances, well known methods, techniques and structures have not been described in detail to avoid obscuring the invention unnecessarily.

In general terms, embodiments of the invention provide wearable air purification systems, or ‘air purifiers’, that provide active filtering of air in an unobtrusive package that resembles consumer audio headphones. Indeed, in some cases the air purifier includes audio equipment to provide audio functionality as a secondary function.

To build on the approach set out in WO 2020/021231, in the present embodiments air delivery is effected by a small, high speed motor that can be positioned in the system with enhanced flexibility. By way of example, the motor used in the system shown in WO 2020/021231 may have an operating speed in the order of 10′000 rpm, and is of a size that dictates a central position within an enlarged earpiece. In contrast, embodiments of the invention use higher speed motors that are correspondingly smaller. For example, the motor may have an operating speed in the order of 100′000 rpm. Accordingly, the motor can be housed unobtrusively within the visor, in an off-centre position inside an earpiece, or in a separate housing, in each case offering reduced packaging requirements and in turn an improved user experience.

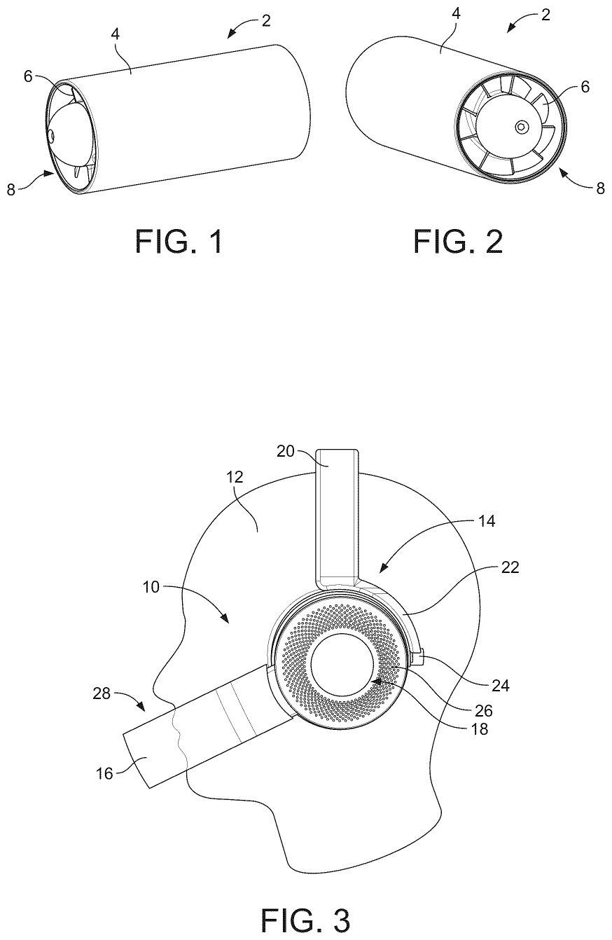

An example of a compressor 2 incorporating such a motor for use in embodiments of the invention is shown in FIGS. 1 and 2. The compressor 2 has a tubular outer housing 4 that contains the motor (not visible), which occupies much of the internal space of the housing 4, and an impeller 6 arranged to spin on an axis corresponding to a central axis of the housing 4. The housing 4 is open-ended, with a rear open end defining a compressor inlet and a front open end defining a compressor outlet 8.

The motor typically has a diameter in the range of approximately 5-10 mm in this embodiment, although this may vary in other embodiments. It follows that the housing 4 has a diameter in the order of 15-25 mm, with the impeller 6 being sized accordingly.

Terminals (not shown) at the rear of the compressor 2, as viewed in FIGS. 1 and 2, are configured to receive electrical power that is used to drive the motor. The motor is coupled to and drives the impeller 6 to pressurise air to generate a flow of air, thereby drawing air into the compressor inlet and discharging air through the compressor outlet 8.

In some embodiments, the air purifier is substantially symmetrical, in that the earpieces are substantially identical and a pair of motors is provided, one on each side of the visor, each motor being associated with a respective earpiece. Such arrangements offer balanced air delivery, balance the weight of the purifier, and reduce the power demands on each individual motor.

However, it is also possible for the system to have a single motor and thereby reduce costs and overall weight, in which case air flow can be distributed evenly over the output area around the user's nose and mouth using flow routing features in the visor. Such embodiments may be particularly suited for products intended for children, as children have half the breathing rate of adults on average. Alternatively, a more powerful motor may be used for an adult version of the system.

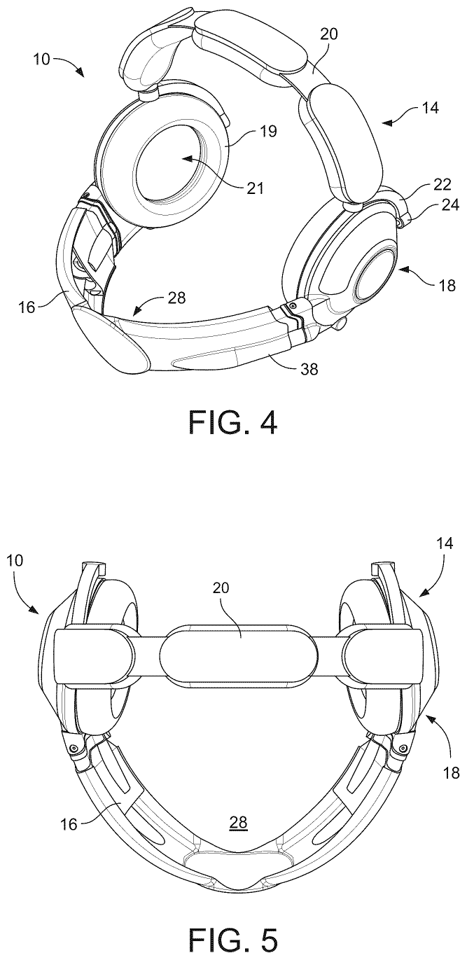

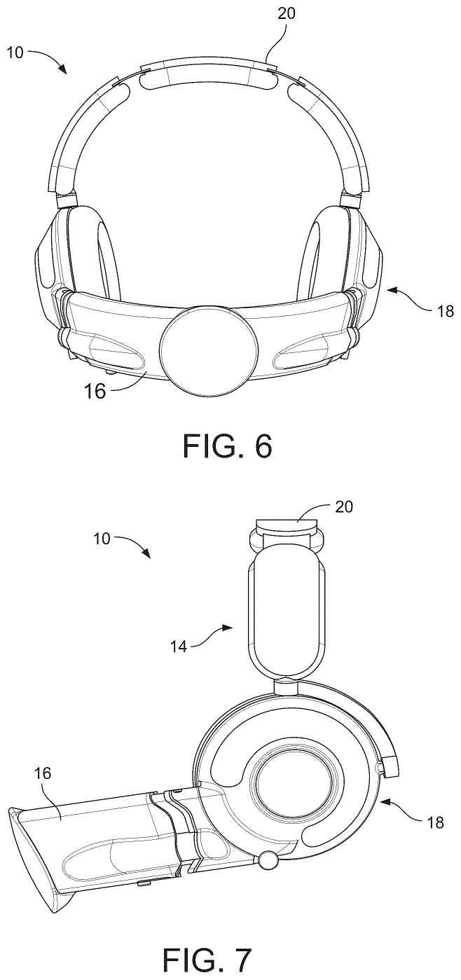

An example of such an ‘air purifier’ 10 is now described with reference to FIGS. 3 to 9. FIG. 3 shows an air purifier 10 in simplified form in use on a user's head 12, and is referred to for general details of the purifier 10 that are applicable to various embodiments of the invention. FIGS. 4 to 8 provide a range of views of a more specific embodiment of the air purifier 10. FIGS. 3 to 8 are referred to collectively in the following description.

The air purifier 10 shown here is similar to devices disclosed in prior publications belonging to the Applicant, such as GB2582372 and WO 2020/021231. A full discussion of the air purifier 10 will not be provided here for brevity, but a summary is provided below for completeness.

As FIG. 3 shows, the air purifier 10 comprises a support assembly 14 that is worn on the user's head 12, and an air delivery mask in the form of visor 16 that attaches to the support assembly 14.

The support assembly 14 includes a pair of earpieces 18 that are each arranged to engage a respective one of the user's ears, an ear pad 19 being provided on each earpiece 18 to create a cushioned interface for the user's ear. The earpieces 18 are connected by a support member, or ‘headband’ 20, which is arranged to extend over the user's head 12. Accordingly, the support assembly 14 has the general appearance of consumer audio headphones. Indeed, each earpiece 18 includes audio equipment in the form of a speaker assembly 21, and so can provide audio playback to function as headphones. Each speaker assembly 21 includes a speaker unit comprising a speaker and speaker electronics. A Bluetooth or other type of wireless communication transmitter/receiver may be provided for wireless communication with an audio playing device.

The earpieces 18 are coupled to the headband 20 by a conventional movable or rotatable coupling, embodied here by an arcuate arm 22 that extends about a portion of a respective earpiece 18 and engages with that earpiece 18 by a rotational pivot pin 24. Further discussion of this coupling will be omitted for brevity.

As is conventional, the headband 20 is curved and resilient, with the earpieces 18 being close together or even touching when the support assembly 14 is in a rest position. Accordingly, the headband 20 must be stretched to fit the earpieces 18 over the user's ears, and in doing so the resilience of the headband 20 generates a small lateral force that urges the earpieces 18 towards each other and therefore into engagement with the user's ears, thereby holding the support assembly 14 on the user's head 12.

Although in this example the air purifier 10 is designed such that the wearable support member, namely the headband 20, fits over the head 12 of a user, it is envisaged that this need not be the case and that in some examples the wearable support may fit around the back of the head 12 or even around the neck area. For the purposes of this discussion, however, the wearable support will be referred to generally as a ‘headband’, although this should be interpreted as extending to similar bands, straps or similar structures that fit around or onto other parts of the head area of the user.

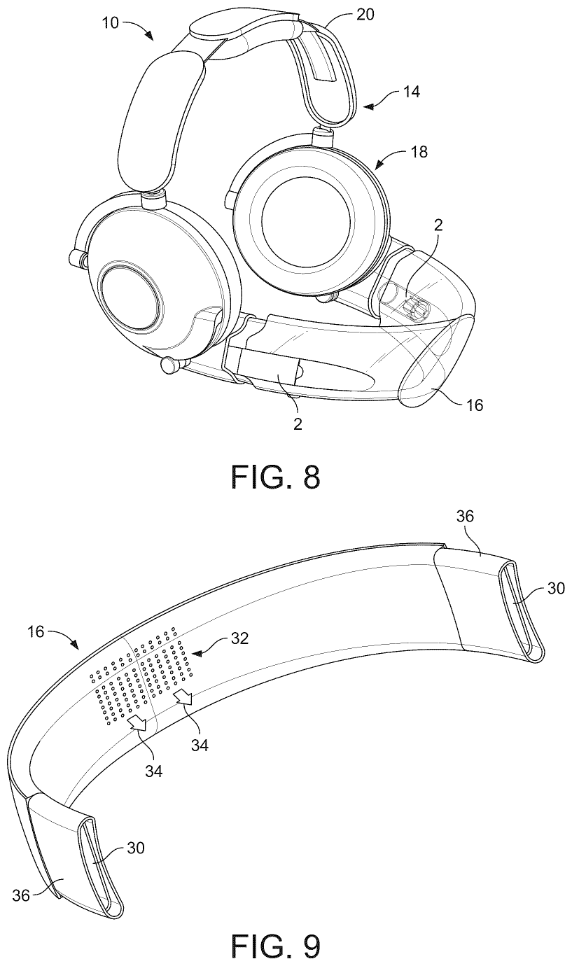

Each earpiece 18 further includes a filter 26 that is generally annular and has an outer periphery offset slightly inwardly of the periphery of the earpiece 18 itself, whilst leaving a central region of the earpiece 18 clear to accommodate the audio equipment. Air can be drawn through the filter 26 under the action of a suitable airflow generator such as the compressor 2 shown in FIGS. 1 and 2, and directed into the visor 16. The position of the compressor 2 is shown in FIG. 8 and is described in more detail later.

The visor 16 extends forward of the headband 20 and the earpieces 18 with a downward inclination, so that the visor 16 is approximately at an 8 o'clock position with respect to the headband 20 in the view shown in FIG. 3. Accordingly, the visor 16 wraps around the user's mouth to convey air that has been received from the filters 26 in the earpieces 18 of the support assembly 14 to an air delivery region 28 in the vicinity of the user's nose and mouth.

In this respect, as best seen in the simplified view of FIG. 9, the visor 16 is a hollow shell that defines suitable airflow pathways, ducts and channels 30 that convey a flow of filtered air to the air delivery region 28. Air thus conveyed is discharged into the air delivery region 28 through an outlet in the form of at least one nozzle 32, which may be embodied by a grille or array of holes as appropriate.

The flow of air is indicated in FIG. 9 as ‘34’, and the nozzle 32 is configured to ensure that this flow 34 is substantially perpendicular to the user's face. This entails turning the flow of air in the channel 30 through substantially a right angle, and the skilled person will be aware of various ways to achieve this. For example, the individual openings of the nozzle 32 may be sized such they have a depth that approximately three times their diameter, which has been found to be an effective geometry for directing airflow. Other flow redirecting features that may be employed can include turning vanes, meshes, hole patterns and converging jets, for example. When incorporating such features, consideration may also be given to the aesthetic impact, noting a general objective in many embodiments to maximise the transparency of the visor 16 and in turn minimise any visual obstruction of the user's facial features.

The visor 16 is substantially symmetrical about a central axis intersecting the outlet, such that respective portions of the air channel 30 extend towards each other from the open ends of the visor 16 to converge at the nozzle 32. These portions of the airflow channel, although continuous with one another in this example, may be considered to represent first and second airflow channels 30, each air channel 30 being associated with a respective earpiece 18 in the sense that each air channel 30 conveys air received from its respective earpiece to the nozzle 32.

In this example, the visor 16 is in the general form of an elongate curved bar, and is made from a rigid plastics material such as polycarbonate, although this is entirely optional.

The visor 16 includes a generally rectangular male end connector 36 at each end, each end connector 36 being arranged to interface with a corresponding female port in the corresponding earpiece 18 to define a disengageable coupling between the visor 16 and the respective earpiece 18. Accordingly, the visor 16 is detachable from the support assembly 14, so that the support assembly 14 can be used as a pair of headphones when air purification is not required.

The couplings between the ends of the visor 16 and the ports of the earpieces 18 may be flexible to allow for a degree of pivoting or swivelling of the visor 16 with respect to the earpieces 18. For example, the end connectors 36 of the visor 16 may be formed from a short section of flexible hose, e.g. of silicone rubber. Although not shown here, the coupling may also be embodied by a rotational joint to allow the visor 16 to pivot rotationally downwards out of the way of the user's mouth.

The purifier 10 also comprises a battery pack (not shown) for supplying electrical power to the components of the purifier. The battery pack may be incorporated into one of the earpieces 18, for example, in which case power may be transmitted from the battery pack to the other earpiece 18 through wires embedded in the headband 20. Alternatively, each earpiece 18 may comprise its own battery pack, or the battery pack can be accommodated in the headband 20.

Turning now to FIG. 8, the visor 16 is shown in translucent form to reveal a pair of compressors 2 housed within side regions of the visor 16. Each compressor 2 is accommodated within an enlarged portion of a respective one of the first and second air channels 30, at a location between the nozzle 32 and the respective earpiece 18. In this example, the compressors 2 are each positioned closer to their respective earpieces 18 than to the nozzle 32, and are offset from their earpieces 18 to an equal extent such that the purifier has overall symmetry about an axis intersecting the nozzle. The compressors 2 therefore locate beside the user's face when the air purifier 10 is worn.

The enlarged portions of the air channels 30 that accommodate the compressors 2 give rise to corresponding protrusions 38 on each side of the outwardly-directed exterior of the visor 16. It is noted that these protrusions 38, although they add some bulk to the visor 16, do not add any bulk in areas of the visor 16 extending across the user's face. Accordingly, this arrangement allows the compressors 2 to be accommodated in the visor 16 without creating any further obstruction of the user's face. Moreover, the small size of the compressor 2 minimises the additional bulk entailed for the visor 16.

In principle, however, the compressors 2 may be housed anywhere in the visor 16, including adjacent to or in front of the air channel outlet defined by the nozzle 32.

Each compressor 2 is therefore associated with, and operable to generate a flow of air through, a respective earpiece 18. More specifically, each compressor 2 operates to draw incoming air through the filter 26 of the associated earpiece 18, through the port of the earpiece 18 and into the respective air channel 30 of the visor 16 to enter the inlet of the compressor 2. From there, the compressor 2 forces air out from its compressor outlet 8, through the remainder of the air channel 30, and out through the nozzles 26 to provide a flow of fresh, filtered air to the user. Due to the inclination of the visor 16, this flow is directed at an oblique angle relative to the user's nose or mouth, increasing comfort and avoiding recirculation of exhaled air within the air delivery region 28.

Each of the end connectors 36 of the visor 16 includes electrical contact points defining electrical terminals (not visible), which connect to corresponding terminals, for example spring-loaded connectors, in the female ports of the earpieces 18 when the visor 16 is connected to the earpieces 18. In turn, the terminals of each compressor 2 are connected by wires or other suitable conduction paths to the terminal of the nearest end connector 36. In this way, electrical power can be delivered from the battery pack to the compressors 2 to power the motors when the visor 16 is attached to the support assembly 14. It is noted that the visor 16 may include further electrical connections associated with other features, such as lighting, sensing equipment and microphones.

Conversely, if the visor 16 is removed from the support assembly 14, beneficially this also entails removing the compressors 2. So, the weight of the support assembly 14 when it is being used solely as a set of headphones is minimised, as the user does not need to carry the weight of the visor 16 or the compressors 2 when they are not in use.

When the visor 16 is attached to enable the purification function, the use of two compressors 2, one on each side of the purifier 10, balances the weight of the arrangement to maximise user comfort. Using two compressors 2 also allows each individual compressor 2 to be less powerful, and therefore lighter, than would be the case if a single compressor were used.

It is noted further that the symmetry of the arrangement allows for an even distribution of filtered air into the air delivery region 28, as the air flow rate through each air channel on each side of the purifier 10 is substantially the same.

More generally, moving the compressors 2 out of the earpieces 18, as compared with the Applicant's earlier design shown in WO 2020/021231, allows the size of the earpieces 18 to be reduced such that they are closer in size and appearance to those of conventional headphones. Moreover, the compressors 2 are spaced from the user's ears and therefore the impact of the noise generated by the compressors 2 in operation is reduced to minimise irritation to the user. In this respect, the earpieces 18 themselves provide a degree of noise damping, and this may be further enhanced if the earpieces 18 incorporate active noise cancelling technology. A further advantage relative to the arrangement of WO 2020/021231 is that the earpieces 18 of the present embodiment are less complex, since they do not include a compressor or a motor and are thus easier to assemble and seal.

However, as noted above in other embodiments a single motor or compressor 2 may be used to deliver air to the air delivery region 28. This may reduce the overall weight of the purifier, albeit at the expense of balance. Such arrangements may be particularly suited for variants intended for children, for example, which may not require the additional power of the second compressor as children breathe at a slower rate than adults. Alternatively, a larger compressor may be used to provide similar total air flow to the purifier of FIGS. 4 to 8.

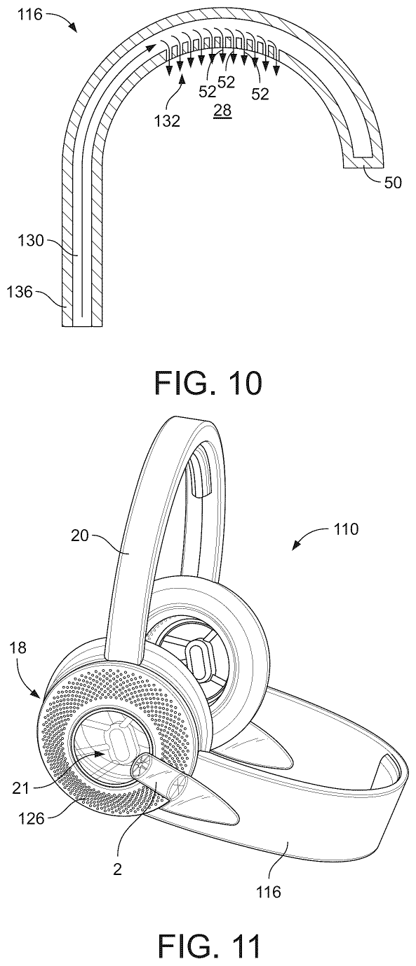

In this respect, FIG. 10 shows a visor 116 that may be used in such embodiments. Unlike the symmetrical visor 16 of FIG. 9, which connects to both earpieces 18, the visor 116 shown in FIG. 10 is J-shaped when viewed from above.

The longer side of the visor 116, shown to the left in FIG. 10, includes a male end connector 136 similar to that of FIG. 9, which couples to a corresponding port of one of the earpieces 18. However, the other end of the visor 116, shown to the right in FIG. 10, does not extend back to the opposite earpiece 18, but instead extends only to the extent required to bound the air delivery region 28 and terminates at a closed end 50 that is spaced from the corresponding earpiece 18 when the visor 116 is attached. Thus, the visor 116 is effectively cantilevered from a single point of attachment to the support assembly 14 of the purifier 10.

The visor 116 is hollow to define an internal air channel 130 as in the previous embodiment, although this air channel 130 cannot be considered to represent distinct portions as in the previous embodiment, as air flows in one direction only in the visor 116 of FIG. 10, as indicated by the arrows. Specifically, an air flow is received from the earpiece 18 to which the visor 116 is connected via the end connector 136, and flows from there to be discharged through an outlet nozzle 132.

To compensate for the loss of air flow on one side, the nozzle 132 of this embodiment includes flow routing features configured to distribute air coming from one side of the visor 116 evenly across the air distribution region 28. Specifically, in this example the nozzle 132 comprises a linear array of openings 52 that extend across the air delivery region 28 and collectively define an outlet. The openings 52 are configured such that their relative sizes, angles and spacing of the openings 52 discourages all of the air received from the air channel 130 from exiting via the first opening it reaches, and encourages the received air flow to exit progressively through the series of openings 52 so that a portion of the received air continues until finally exiting through the opening furthest to the right in FIG. 10. The specific geometry of the openings 52 can be varied and optimised to suit each application according to known principles of aerodynamics.

It is also noted that the same considerations apply as for the visor of FIG. 9 in terms of providing air flow that is perpendicular to the user's face. In this respect, the view shown in FIG. 10 makes clear that the openings 52 are approximately three times as long as they are wide, which provides the required flow directing action. More generally, any of the flow redirecting features mentioned above may also be incorporated into the visor 116 of FIG. 10.

The visor 116 is otherwise similar to that of FIG. 9. In particular, although omitted from FIG. 10 for clarity, the air channel 130 of the visor 116 includes an enlarged portion to accommodate a compressor 2, along with the requisite terminals and conductive paths to deliver electrical power to the compressor 2 from the respective earpiece 18.

FIG. 11 shows a variant 110 of the air purifier 10 of FIGS. 4 to 8. The air purifier 110 of FIG. 11 has the same basic structure that is described above with reference to FIG. 3, and is identical to the first specific embodiment of FIGS. 4 to 8 in many respects, and so only the differences are noted here.

Specifically, in the variant 110 shown in FIG. 11 each earpiece 118 comprises a filter 126 that is generally similar to those of the first embodiment, in that it follows a curved path to assume a generally annular shape, but which is modified to introduce a gap or discontinuity in the annulus such that the filter 126 is C-shaped. Accordingly, the filter 126 is discontinuous to define first and second ends that are spaced from one another and define extremities of the curved path of the filter 126.

The compressor 2 is positioned in the gap between the first and second ends of the filter 126 in a common plane with the filter 126, and not in the visor 116 as in the first embodiment. The visor 116 of the embodiment shown in FIG. 11 is therefore simplified relative to that of the first embodiment, as it does not require the enlarged portions of the air channels to the same extent to accommodate the compressors 2. The visor 116 is otherwise similar to that of FIG. 9, and in particular may connect to each earpiece 118 via male end connectors that insert into corresponding female ports of the earpieces 118. Alternatively, each earpiece 118 may be provided with a male protrusion, such as a stud that partially houses the compressor 2, which cooperates with a complementary female socket in the visor 116. Other connection interfaces are also possible.

The use of the smaller compressor 2 relative to the arrangement disclosed in WO 2020/021231 enables the compressor 2 to be located within the annular envelope defined by the filter 126. This off-centre position for the compressor 2 reduces the extent to which noise generated by the compressor 2, in use, interferes with the speaker assemblies 21 and creates unwanted noise for the user.

Meanwhile, retaining the compressors 2 in the earpieces 118 may improve weight distribution relative to the first embodiment, in that the compressors 2 are closer to the point of attachment to the user's ears and thus generate a smaller moment on that attachment point.

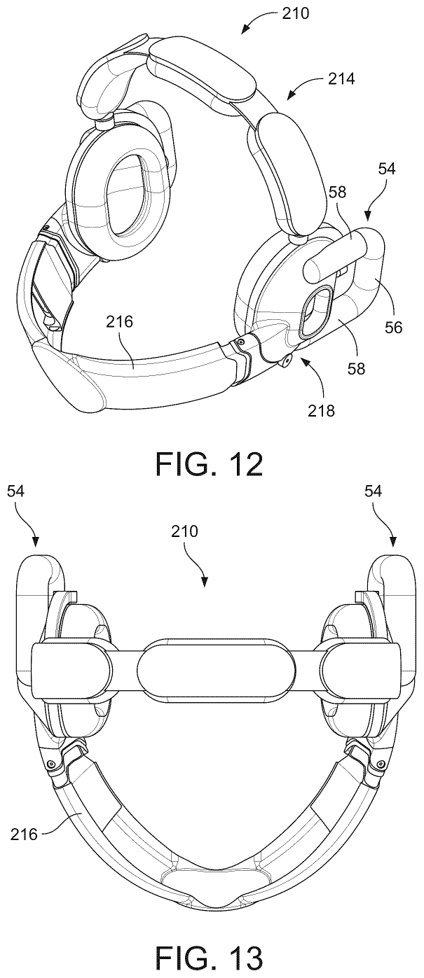

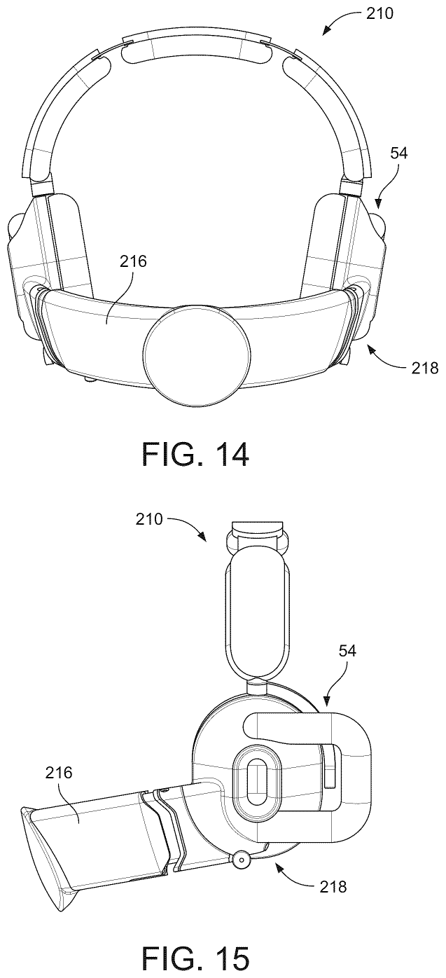

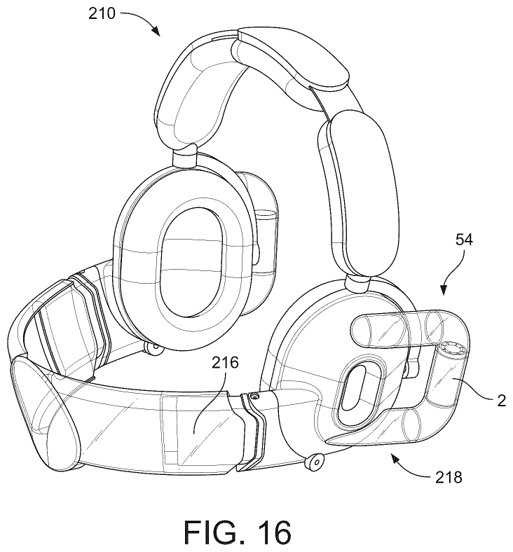

Turning finally to FIGS. 12 to 16, a further variant 210 is shown in which the air purifier 210 includes a dedicated external compressor housing 54 attached to each earpiece 18. As for the embodiment of FIG. 11, the air purifier 210 shown in FIGS. 12 to 16 has the same basic structure that is described above with reference to FIG. 3, and is identical to the specific embodiment of FIGS. 4 to 8 in many respects, and so only the differences are noted here.

Each compressor housing 54 takes the form of a bent tube to define a U-shaped body that connects to the rear of a respective earpiece 218 to extend rearwardly from the support assembly 14. It will be appreciated that the compressor housings 54 may have any suitable shape in practice, and so the housings 54 shown in FIGS. 12 to 16 are purely illustrative.

As FIG. 16 reveals, each compressor 2 is housed in an upright portion 56 of the respective compressor housing 54 extending between and connecting parallel horizontal portions 58 of the housing 54. The compressor 2 is oriented generally vertically when the purifier 210 is in the normal position on the user's head 12.

Above the compressor 2, an upper one of the horizontal portions 58 of the housing 54 extends towards the earpiece 218 to which the housing 54 is connected, before terminating at an open end defining an intake of the housing 54.

Below the compressor 2, the lower of the horizontal portions 58 of the housing 54 connects the housing 54 to the earpiece 218 using a similar male-female interface to the visor couplings formed by the end connectors and ports. The compressor housing 54 is therefore detachable from the earpiece 218 in a similar way to the visor 216. In other embodiments, however, the compressor housings 54 may be fixed to their respective earpieces 218 in a more permanent manner to simplify the arrangement.

Internally, the compressor housing 54 is hollow to define a continuous air flow passage within which the compressor 2 is located. Accordingly, the compressor 2 is operable to draw air into the compressor housing 54 through the intake, and to force air into the earpiece 18, through the filter 26 and on into the visor 216 to be discharged into the air delivery region 28.

As for the embodiment shown in FIG. 11, the visor 216 shown in FIGS. 12 to 16 is simpler than that of FIGS. 4 to 9 by virtue of not needing to accommodate the compressors 2. Indeed, the visor 216 of FIGS. 12 to 16 may be substantially identical to that of FIG. 11.

Accordingly, the embodiment shown in FIGS. 12 to 16 offers similar benefits to that of FIGS. 4 to 8, in that the visor 216 and compressor housings 54 can be removed to leave only the support assembly 14 when only audio functionality is required, in which case the weight of the compressors 2 is beneficially avoided.

Also, as for the first embodiment, in the arrangement shown in FIGS. 12 to 16 the compressors 2 are located remote from the user's ears to minimise noise. Indeed, locating the compressors 2 behind the user's ears may be of particular benefit in this respect, as it is believed that noise originating from behind the ears may be less noticeable for the user due to the shape of human ears.

It is also possible to integrate the compressor housings 54 with the visor 216, such that the visor 216 and the housings 54 can be attached to and removed from the support assembly 214 as a single entity.

The variants shown in FIG. 11, or FIGS. 12 to 16, can be adapted as single compressor versions in a similar manner to the first embodiment, by using visors configured as shown in FIG. 10.

In summary, the air purifiers described above provide the dual functionality of air purification and audio playback in a discreet package that minimises user discomfort.

Moreover, the purifiers offer versatility of use by virtue of the ability to remove the air filtering components such that the system can be used purely for audio playback whilst closely resembling consumer headphones.

It will be appreciated that various changes and modifications can be made to the present invention without departing from the scope of the present application.

For example, although the embodiments described above include air filters that are integrated into earpieces, the position of the filters is flexible. For example, filters may alternatively be integrated into a visor or a headband, or into a separate support housing. It is also noted that in some variants the support assembly does not include earpieces.

Although the above embodiments include compressors that integrate motors and impellers, it is also possible for the motor and impeller to be implemented as separate components.

In general terms, the positions of the motor and the filter can be varied according to the requirements of each application to strike a desired balance between comfort, aesthetics, acoustics and weight balance, among other factors.

1: A wearable air purification system comprising:
a support assembly, comprising:
a first earpiece arranged to engage a first ear of a user, the first earpiece comprising an air filter;
a second earpiece arranged to engage a second ear of the user; and
a support member connecting the first earpiece to the second earpiece, the support member being arranged to be worn around the user's head;
an air delivery mask connected to the support assembly, the air delivery mask being shaped to bound an air delivery region that contains the user's nose and/or mouth, in use, the air delivery mask comprising an outlet in the air delivery region and an air channel configured to deliver a flow of air from the air filter to the outlet; and
a motor arranged to drive an impeller to pump air through the air channel to the air delivery region, the motor being housed in the first earpiece and being radially offset from a centre of the air filter.

2: The system of claim 1, wherein the air filter extends around a curved path from a first end to a second end, the first and second ends being spaced from each other, and wherein the motor is disposed in a gap between the first end and the second end of the filter.

3: The system of claim 2, wherein the curved path is generally annular.

4: The system of claim 3, wherein the air filter is C-shaped.

5: The system of claim 1, wherein the motor lies in a common plane with the air filter.

6: The system of claim 1, wherein the first and second earpieces each comprise a respective air filter, each air filter being arranged to deliver filtered air to the air channel of the air delivery mask.

7: The system of claim 6, wherein the first and second earpieces each comprise a respective motor arranged to drive a respective impeller to pump air through the air channel to the air delivery region, each motor being radially offset from a centre of the respective air filter.

8: The system of claim 1, wherein the air delivery mask is connected to the first earpiece.

9: The system of claim 1, wherein the air delivery mask is connected to the second earpiece.

10: The system of claim 1, wherein the first earpiece and the second earpiece each comprise a respective audio device.

11: The system of claim 10, comprising a communications module configured to receive a signal comprising audio data.

12: The system of claim 1, wherein the air delivery mask outlet comprises a set of openings arranged in succession from one side of the air delivery region to the other, to distribute air flow from the air channel over the air delivery region.

13: The system of claim 1, comprising a pump that comprises the motor and the impeller.

14: The system of claim 1, wherein the system is substantially symmetrical about an axis intersecting the air delivery region.

15: The system of claim 1, wherein the air delivery mask is coupled to the support assembly by one or more disengageable couplings such that the air delivery mask is detachable from the support assembly.
